(19) United States
(12) Patent Application Publication
(10) Pub. No.: US 2021/0408753 A1
(43) Pub. Date: Dec. 30, 2021

(54) PUSH DEVICE, WIRE PROCESSING DEVICE AND METHOD OF PROCESSING WIRE

(71) Applicants: TYCO ELECTRONICS (SHANGHAI) CO., LTD., Shanghai (CN); TE CONNECTIVITY GERMANY GMBH, Bensheim (DE)

(72) Inventors: Zhen WANG, Shanghai (CN); Yiqun (Cham) ZHU, Shanghai (CN); Siegfried BECK, Feuchtwangen (DE)

(21) Appl. No.: 17/357,373

(22) Filed: Jun. 24, 2021

(30) Foreign Application Priority Data
Jun. 30, 2020 (CN) 202010615394.7

(51) Int. Cl. H01R 43/20; H02G 15/18; H01R 4/72

(52) U.S. Cl. CPC H01R 43/20; H01R 4/72; H02G 15/1806

(57) ABSTRACT

The present invention relates to a push device, a wire processing device and a wire processing method. The push device comprises of: a driving device configured to generate a driving force; a transmission mechanism flexibly connected with the driving device; and a pushing part fixedly connected with the transmission mechanism and being movable under the drive of the transmission mechanism. When the pushing part is moved, the pushing part transmits a pushed part to a predetermined position; when the pushed part is transmitted to the predetermined position, the driving force of the driving device stops acting on the driving mechanism. In the present invention, the driving device drives the pushing part to move by the transmission mechanism, and when the pushing part moves, the insulation heat shrinkable tube is pushed to a predetermined position to facilitate the next processing operation. At least one of the two pushing parts is movable to push the insulation heat shrinkable tube to the predetermined position.

### CROSS-REFERENCE TO RELATED APPLICATION

This application claims the benefit of Chinese Patent Application No. 202010615394.7 filed on Jun. 30, 2020 in the State Intellectual Property Office of China, the whole disclosure of which is incorporated herein by reference.

### BACKGROUND OF THE INVENTION

### Field of the Invention

The present invention relates to a push device, a wire processing device and a method of processing wire.

### Description of the Related Art

When splicing two bundles of wires, it is necessary to cut off a section of the insulation skin of the two bundles of wires and expose part of the conductors respectively. Each bundle of wires can be either one or multiple. The bare conductors of two bundles of wires are spliced by ultrasonic welding, and then a section of insulation heat shrinkable tube is sleeved on the bare conductor. During processing, the insulation heat shrinkable tube is heated so that the insulation heat shrinkable tube tightly wrapped on or bonded with the insulation skin of two bundles of wires to cover the exposed conductor. During the automatic processing, it is necessary to place the insulation heat shrinkable tube in a predetermined position in advance. After the insulation heat shrinkable tube covers the entire bare conductor, it is heated. How to automatically transfer the insulation heat shrinkable tube to the predetermined position is one of the technical problems in the art.

### SUMMARY OF THE INVENTION

The present invention has been made to overcome or alleviate at least one aspect of the above mentioned disadvantages.

According to an aspect of the present invention, there is provided a push device, comprising: a driving device configured to generate a driving force; a transmission mechanism flexibly connected with the driving device; and a pushing part fixedly connected with the transmission mechanism and being movable under the drive of the transmission mechanism. When the pushing part is moved, the pushing part transmits a pushed part to a predetermined position; when the pushed part is transmitted to the predetermined position, the driving force of the driving device stops acting on the driving mechanism.

According to an exemplary embodiment of the present invention, two pushing parts are provided, and at least one of the two pushing parts is movably provided, and the movable pushing part is configured to be moved close to or far away from the other pushing part.

According to another exemplary embodiment of the present invention, the driving device simultaneously drives the two pushing parts to move close to each other or far away from each other through the transmission mechanism.

According to another exemplary embodiment of the present invention, the transmission mechanism comprising: a gear; and two racks respectively meshed with the gear and linked through the gear, the two racks are configured to be moved in a straight line in opposite directions and respectively connected with the two pushing parts.

According to another exemplary embodiment of the present invention, the push device further comprises a flexible connecting device, the driving device drives at least one of the two racks to move by the flexible connecting device.

According to another exemplary embodiment of the present invention, the flexible connecting device comprising: a push rod fixedly connected with the driving device and driven to move by the driving device; and a connecting spring, one end of the which butts against the push rod, and the other end directly or indirectly butts against one of the two racks. When the push rod is driven to move by the driving device, the push rod butts the connecting spring and pushes one of the two racks to move by the connecting spring.

According to another exemplary embodiment of the present invention, before the pushed part reaches the predetermined position, the driving force of the driving device is transmitted to the transmission mechanism through the push rod and the connecting spring; when the pushed part reaches the predetermined position, the driving force of the driving device causes the connecting spring to be compressed and deformed, and causes the push rod to move relative to the connecting spring.

According to another exemplary embodiment of the present invention, a flange is provided on the push rod, the connecting spring is sheathed on the push rod and butted against the flange.

According to another exemplary embodiment of the present invention, the flexible connecting device further comprises a first block connected with one of the two racks and butts against the other end of the connecting spring; the push rod passes through the first block and is provided with a gap with the first block.

According to another exemplary embodiment of the present invention, the flexible connecting device further comprising: a second block; and a connecting member configured to connect the first block and the second block, the first block is spaced from the second block, the push rod passes through the second block and is movably provided relative to the second block, the connecting spring is sheathed on the push rod and is located between the first block and the second block, a flange is provided on the push rod, one end of the connecting spring butts against the flange and the other end butts against the first block.

According to another exemplary embodiment of the present invention, the flange is provided in contact with the second block during movement; and when the driving device generates a reverse driving force, the flange pushes the second block to move in a reverse direction.

According to another exemplary embodiment of the present invention, the push device further comprises a push rod position sensor; when the push rod is displaced relative to the connecting spring, the push rod position sensor detects the position of the push rod and generates a control signal to control the driving device to work.

According to another exemplary embodiment of the present invention, the pushing part comprises a limiting piece and a blocking piece, and there is a gap between the limiting piece and the blocking piece; the blocking piece is movably provided, and the gap is adjusted when the blocking piece is moved.

According to another exemplary embodiment of the present invention, the pushing part further comprises an elastic device having elastic force, and the elastic device acts on the blocking piece to move the blocking piece to reduce the gap between the limiting piece and the blocking piece.

According to another aspect of the present invention, there is provided a wire processing device, comprising: a heat shrinkable processing device; and the above push device, the push device configured to transmit an insulation heat shrinkable tube to a predetermined position.

According to another aspect of the present invention, there is provided a method of processing wire, comprising steps of: placing a processed wire at a processed position, wherein the processed wire comprises a splicing part; transmitting an insulation heat shrinkable tube to the splicing part of the processed wire; stopping the transmission of the insulation heat shrinkable tube when the insulation heat shrinkable tube is transferred to cover the splicing part of the processed wire; and heating the insulation heat shrinkable tube so that the insulation heat shrinkable tube is shrunk and wrapped on the splicing part of the processed wire.

The present invention relates to a push device, a wire processing device and a wire processing method. The driving device drives the pushing part to move by the transmission mechanism. When the pushing part moves, the insulation heat shrinkable tube is pushed to the predetermined position to facilitate the next processing operation. There are two pushing part, at least one of which can be moved to push the insulation heat shrinkable tube to the predetermined position. The driving device is flexibly connected with the transmission mechanism, which can not only transfer the driving force to the transmission mechanism, but also stop driving the transmission mechanism when the pushing part pushes the pushed part to the predetermined position, so as to avoid the extrusion damage of the pushing part due to the continuous output of the driving force. When the two pushing parts are linked, the insulation heat shrinkable tube can be pushed from both sides, so that the movement of the pushing parts is more stable and the use is more convenient. One gear and two racks meshed with the gear can simultaneously drive the two pushing parts to move close to each other or far away from each other. The structure is simple and easy to use. The flexible connecting device adopts a push rod and a connecting spring, which can play a buffering role when driving the pushing part to move; The push rod and the connecting spring can be moved relative to each other when the pushing part is moved in place, so as to collect a control signal which indicates that the pushed part is moved in place. The push rod can support the connecting spring and keep it stable when transmitting the driving force. The first block is adopted, and the structure is simple. By using the first block and the second block, the connecting spring can be pre-compressed to have a certain elastic force. When the driving device is started, the first block can be pushed by the elastic force of the connecting spring to reduce the hysteresis of the driving force transmitted to the first block. The position of the push rod can be obtained by using the push rod position sensor. When the push rod moves to a critical position, the control signal is output. According to the control signal which indicates that the push rod has been moved to the critical position, and then the driving device can be controlled to stop working or drive the push rod backward. The gap between the blocking piece and the limiting piece can be adjusted, and the present invention can be applied to wires and heat shrinkable tubes with various diameters. The elastic device is used to help the blocking piece and the limiting piece clamp the wire, which can not only maintain the stability of the wire in the alignment process, but also ensure that the insulation heat shrinkable tube will be pushed to the predetermined position.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative view of structure and use mode of a push device according to an exemplary embodiment of the present invention;

FIG. 2 is an illustrative structural view of a flexible connection device and a transmission mechanism according to an exemplary embodiment of the present invention;

FIG. 3 is an illustrative partial structural view of the flexible connection device according to an exemplary embodiment of the present invention;

FIG. 4 is an illustrative partial exploded view of the flexible connection device according to an exemplary embodiment of the present invention;

FIG. 5 is an illustrative structural view of a pushing part according to an exemplary embodiment of the present invention;

FIG. 6 is an illustrative exploded view of the pushing part according to an exemplary embodiment of the present invention; and

FIG. 7 is is an illustrative view of structure and use state of the push device according to an exemplary embodiment of the present invention.

### DETAILED DESCRIPTION OF PREFERRED EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a push device, comprising: a driving device configured to generate a driving force; a transmission mechanism flexibly connected with the driving device; and a pushing part fixedly connected with the transmission mechanism and being movable under the drive of the transmission mechanism. When the pushing part is moved, the pushing part transmits a pushed part to a predetermined position; when the pushed part is transmitted to the predetermined position, the driving force of the driving device stops acting on the driving mechanism.

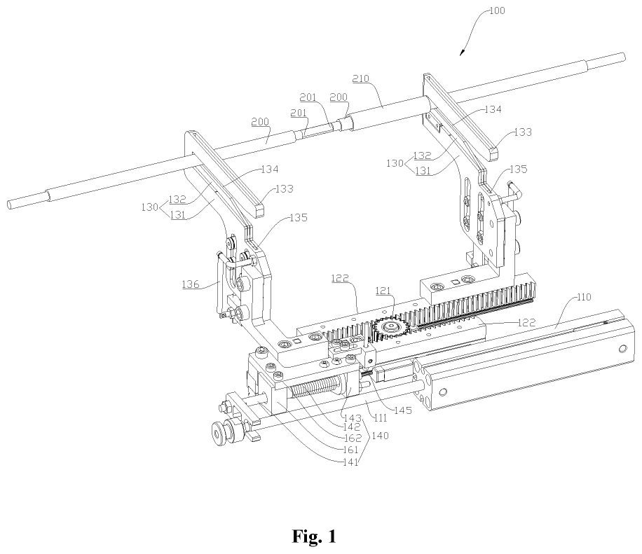

As shown in FIG. 1, the push device 100 comprises a driving device 110, a transmission mechanism 120 and a pushing part 130. The driving device 100 generates a driving force, which is transmitted to the pushing part 130 through the transmission mechanism 120 to drive the pushing part 130 move. When the pushing part 130 moves, it drives a pushed part to move and transmits the pushed part to a predetermined position. When applied to the wire processing, the push device 100 can push the insulation heat shrinkable tube 210 to cover the exposed conductor 201 by the push piece 130.

The driving device 110 is a device for generating driving force, which can adopt various power output mechanisms, such as motors, cylinders, etc. In the illustrated embodiment, the driving device 110 is an air cylinder, and the driving device 110 has a piston rod 111. The piston rod 111 is retractable.

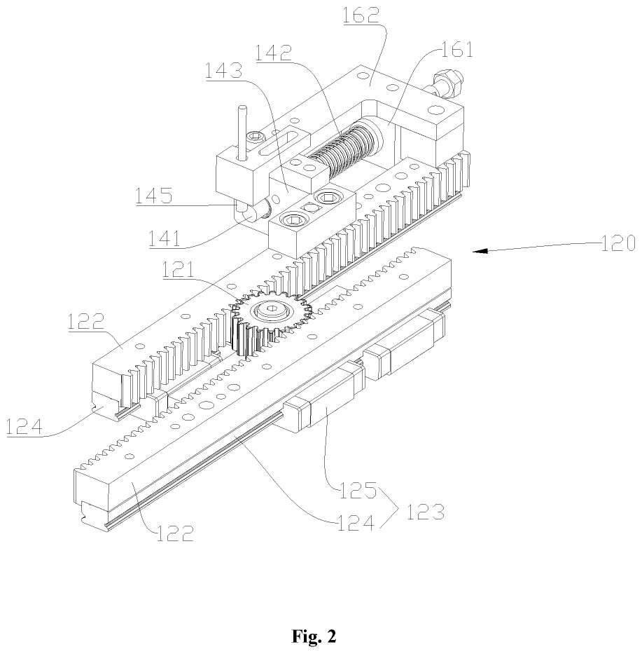

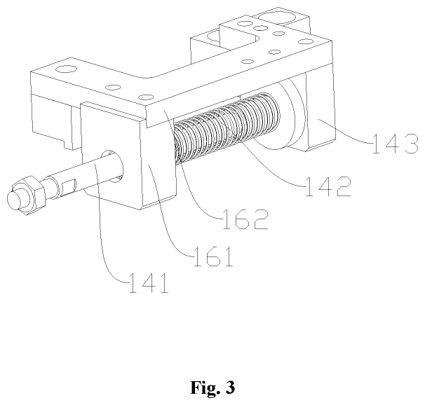

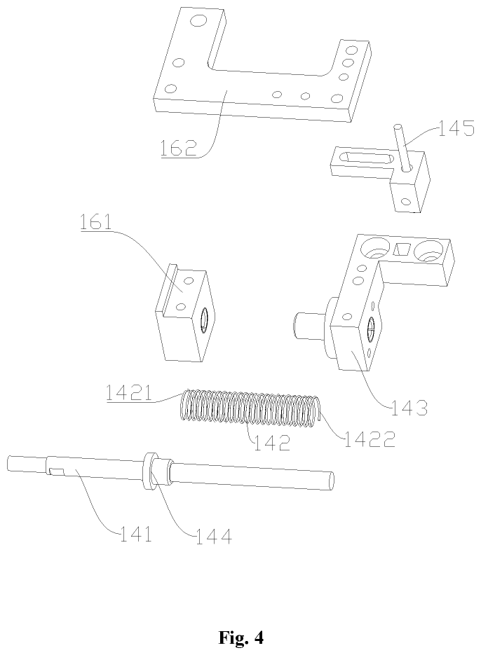

As shown in FIGS. 1-4, in an embodiment, the push device 100 also includes a flexible connection device 140. The flexible connecting device 140 comprises a push rod 141, a connecting spring 142, a first block 143 and a second block 161. The connecting spring 142 is sheathed on the push rod 141, and the push rod 141 extends from one end 1421 of the connecting spring 142 to the other end 1422 to support the connecting spring. The push rod 141 is provided with a flange 144. The push rod 141 passes through the first block 143 and the second block 161, and is provided with clearance with the first block 143 and the second block 161, so that the push rod 141 can move relative to the first block 143 and the second block 161. The first block 143 is spaced from the second block 161. The flange 144 is located between the first block 143 and the second block 161. The flange 144 is blocked by the second block 161 and cannot pass through the second block 161. When the push rod 141 is active, the flange 144 can only move between the first block 143 and the second block 161. The connecting spring 142 is located between the flange 144 and the first block 143. One end 1421 of the connecting spring 142 is against the flange 144, and the other end 1422 is against the first block 143. The flange 144 is located and movable between the first block 143 and the second block 161. The flange 144 is blocked by the first and second block 161 and can contact with the second block 161 during movement. The connecting member 162 connects the first block 143 and the second block 161.

The push rod 141 is connected with the piston rod 111. The driving device 110 drives the push rod 141 to move by the piston rod 111. When the push rod 141 moves, it can press against one end 1421 of the connecting spring 142 through the flange 144 to transfer the driving force to the first block 143. When the resistance of the first block 143 is less than the driving force, the connecting spring 142 is not deformed or slightly deformed, and the first block 143 is driven to move. When the resistance of the first block 143 is greater than the driving force, the connecting spring 142 is compressed and deformed, the push rod 141 moves relative to the connecting spring 142, and the length of the push rod 141 passing through the first block 143 increases gradually.

A push rod position detection device 145 is arranged on the moving route of the push rod 141. The push rod position detection device 145 can detect whether the push rod 141 reaches a critical position. The push rod position detection device 145 may use a proximity switch. When the end of the push rod 141 is close to the push rod position detection device 145, the push rod position detection device 145 outputs a control signal. The upper computer can control the driving device 110 to stop working or drive the push rod 141 to move reversely according to the control signal output by the push rod position detection device 145.

The transmission mechanism 120 comprises a gear 121 and two racks 122. The two racks 122 are respectively meshed with the gear 121 and linked through the gear 121. The gear 121 is rotatably arranged. When the gear 121 rotates, the two racks 122 are driven to move in a straight line in opposite directions. In order to maintain the stability of the rack 122 in the moving process, the present invention is also provided with a guide device 123, which is used for guiding when the rack 122 moves. In the illustrated embodiment, the guide device 123 includes a guide rail 124 and a sliding block 125. The sliding block 125 and the guide rail 124 can be matched and arranged in a relative sliding manner. The sliding block 125 is fixed and the guide rail 124 can slide. The rack 122 is connected with the guide rail 124. One rack 122 is fixedly connected with the first block 143. The connecting member 162 is also fixedly connected with the rack 122, that is to say, the first block 143 can be directly connected with the rack 122 or connected with the rack 122 through the connecting member 162. As an alternative embodiment, the connector 162 may not be connected with the rack 122, but only the first block 143 may be connected with the rack 122. When the first block 143 moves, it drives the rack 122 to move, then drives the gear 121 to rotate, and further drives another rack 122 to move.

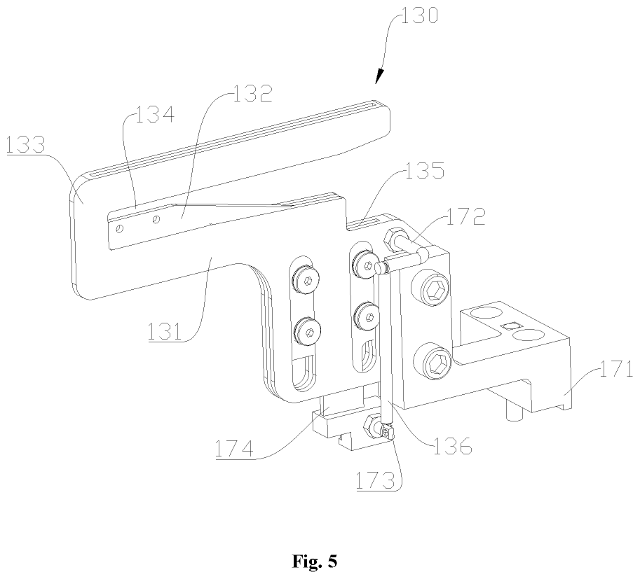

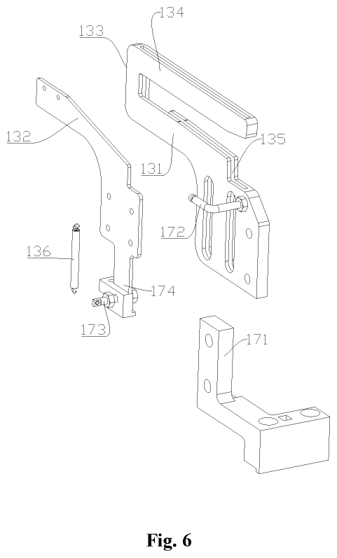

As shown in FIG. 1, FIG. 5 and FIG. 6, the pushing part 130 includes a limiting piece 131 and a blocking piece 132. There is a gap 134 between the limiting piece 131 and the blocking piece 132. The blocking piece 132 is movably arranged, and the gap 134 is adjusted when the blocking piece 132 moves. In the illustrated embodiment, the limiting piece 131 has a U-shaped section 133. The opening of the U-shaped section 133 is the gap 134. The limiting piece 131 has a slot 135. The limiting piece 131 is provided with an upper fixing column 172. The blocking piece 132 is arranged in the slot 135 and can move up and down in the slot 135. The lower end 174 of the blocking piece 132 extends out of the slot 135. The lower end 174 of the blocking piece 132 is provided with a lower fixing column 173. When the blocking piece 132 moves up and down, the size of the gap 134 can be adjusted. An elastic device is arranged on the limiting piece 131, and the elastic device has elastic force, which acts on the blocking piece 132 to make the gap 134 tend to decrease. In the illustrated embodiment, the elastic device is a tension spring 136. The upper end of the extension spring 136 is fixedly connected to the upper fixing column 172 of the limiting piece 131, and the lower end of the extension spring 136 is fixedly connected to the lower fixing column 173 of the blocking piece 132. The force of the extension spring 136 can pull the blocking piece 132 upward to reduce the gap 134. When an object is placed in the gap 134, the limiting piece 131 and the blocking piece 132 clamp the object. The gap 134 can be adjusted to adapt to various sizes of objects. The limiting piece 131 is fixedly connected with the first block 143 through a mounting bracket 171. When the first block 143 moves, the limiting piece 131 is driven to move by the transmission mechanism 120. In the example shown in FIG. 1, there are two limiting pieces 131. Each limiting piece 131 is connected with a rack 122. One of the first blocks 143 butts against the other end 1422 of the connecting spring 142.

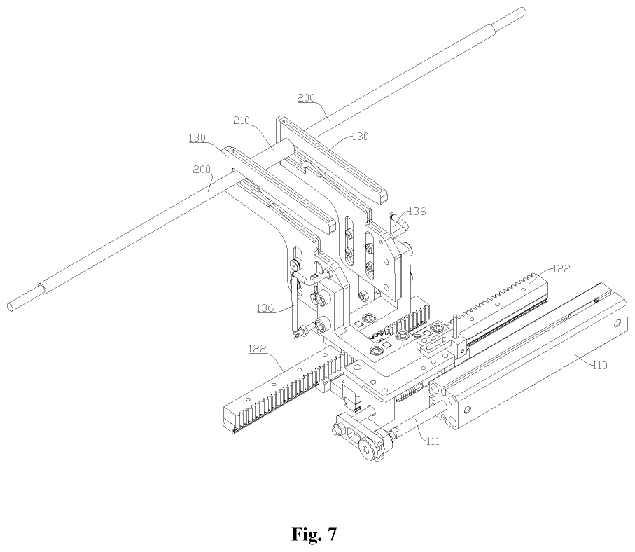

The following is an example of the push device 100 in the present invention for processing wires. After the bare conductors 201 of two bundles of wires 200 are connected, a section of insulation heat shrinkable tube 210 is sheathed on the wire 200. The wire 200 is passed through the gap 134, and the limiting piece 131 and the blocking piece 132 hold the wire 200. The insulation heat shrinkable tube 210 is located between the two pushing parts 130 and can be moved relative to the wire 200. The insulation heat shrinkable tube 210 cannot pass through the gap 134. Therefore, when the pushing part 130 moves, the insulation heat shrinkable tube 210 can be pushed to move. The connecting spring 142 is in a pre-compressed state and has elastic force. The driving device 110 is activated, and the driving device 110 pushes the push rod 141 to move. The push rod 141 drives the flange 144 to move. When the flange 144 moves away from the second block 161, it further compresses the connecting spring 142. The elastic force generated by the pre-compression of the connecting spring 142 and the elastic force generated by the further compression of the flange 144 drive the first block 143 and the second block 161 to move. The connecting spring 142 transmits the driving force to the first block 143 and pushes the first block 143 to move. The first block 143 drives one of the racks 122 to move and then drives the gear 121 to rotate. The rotation of gear 121 drives another rack 122 to move. The moving directions of the two racks 122 are opposite, so the two racks 122 can move towards or away from each other, that is, close to or away from each other. When the two limiting pieces 131 are close to each other, the insulation heat shrinkable tube 210 is pushed to move until the insulation heat shrinkable tube 210 is pushed to the predetermined position as shown in FIG. 7. At this time, when the distance between the two limiting pieces 131 is equal to the length of the insulation heat shrinkable tube 210, that is, the two limiting pieces 131 just touch the two ends of the insulation heat shrinkable tube 210. When the two limiting pieces 131 continue to approach, they are resisted by the insulation heat shrinkable tube 210, and the resistance is transmitted to the first block 143 through the limiting piece 131. When the resistance is greater than the driving force of the driving device, the connecting spring 142 is compressed and the push rod 141 moves relative to the connecting spring 142. The end of the push rod 141 passes through the first block 143 until it enters into a detection range of the push rod position detection device 145, and the push rod position detection device 145 outputs a control signal. According to the control signal, the upper computer judges that the push rod 141 moves to the critical position and is not suitable for further movement, so it controls the driving device 110 to stop working or output the reverse driving force to make the push rod 141 move in the reverse direction. After the insulation heat shrinkable tube 210 is moved to the predetermined position, the driving device 110 drives the stop plate 131 to move in the reverse direction away from the insulation heat shrinkable tube 210 to facilitate the subsequent processing.

After the insulation heat shrinkable tube 210 is pushed to the predetermined position, the two pushing parts 130 are far away from each other for reset. When they reset, the driving device 110 generates a reverse driving force to drive the push rod 141 to move in the reverse direction. When the flange 144 reversely moves to contact with the second block 161, it pushes the second block 161 to move reversely, and then drives the first block 143 and the rack 122 to move reversely through the connecting member 162, and then drives the other rack 122 to move by the gear 121, finally making the two pushing parts 130 away from each other to reset, So that the insulation heat shrinkable tube 210 for the next wire to be processed can be placed between the two pushing parts 130. During this process, the connecting spring 142 is extended. During the reset process, even if the driving device 110 does not generate reverse driving force, the compressed elastic force of the connecting spring 142 causes the flange 144 and the push rod 141 to move reversely, and then the second block 161 to move reversely until it reset.

According to a technical scheme of the present invention, one of the two pushing parts can be movable and the other is fixed. The movable pushing part is moved close to or away from the other pushing part to push the insulation heat shrinkable tube 210 to a predetermined position.

The push device 100 in the present invention can be combined with a wire processing device (not shown) to form a wire processing device to splice and connect two bundles of wires 200. During processing, the push device 100 is used to transmit the insulation heat shrinkable tube 210 to a predetermined position, and then the wire processing device performs the next processing operation.

The present invention also provides a wire processing method, which comprises the following steps of:

placing a processed wire at a processed position, wherein the processed wire comprises a splicing part;

transmitting an insulation heat shrinkable tube to the splicing part of the processed wire;

stopping the transmission of the insulation heat shrinkable tube when the insulation heat shrinkable tube is transferred to cover the splicing part of the processed wire; and

heating the insulation heat shrinkable tube so that the insulation heat shrinkable tube is shrunk and wrapped on the splicing part of the processed wire.

The present invention relates to a push device, a wire processing device and a wire processing method. The driving device drives the pushing part to move by the transmission mechanism. When the pushing part moves, the insulation heat shrinkable tube is pushed to the predetermined position to facilitate the next processing operation. There are two pushing part, at least one of which can be moved to push the insulation heat shrinkable tube to the predetermined position. The driving device is flexibly connected with the transmission mechanism, which can not only transfer the driving force to the transmission mechanism, but also stop driving the transmission mechanism when the pushing part pushes the pushed part to the predetermined position, so as to avoid the extrusion damage of the pushing part due to the continuous output of the driving force. When the two pushing parts are linked, the insulation heat shrinkable tube can be pushed from both sides, so that the movement of the pushing parts is more stable and the use is more convenient. One gear and two racks meshed with the gear can simultaneously drive the two pushing parts to move close to each other or far away from each other. The structure is simple and easy to use. The flexible connecting device adopts a push rod and a connecting spring, which can play a buffering role when driving the pushing part to move; The push rod and the connecting spring can be moved relative to each other when the pushing part is moved in place, so as to collect a control signal which indicates that the pushed part is moved in place. The push rod can support the connecting spring and keep it stable when transmitting the driving force. The first block is adopted, and the structure is simple. By using the first block and the second block, the connecting spring can be pre-compressed to have a certain elastic force. When the driving device is started, the first block can be pushed by the elastic force of the connecting spring to reduce the hysteresis of the driving force transmitted to the first block. The position of the push rod can be obtained by using the push rod position sensor. When the push rod moves to a critical position, the control signal is output. According to the control signal which indicates that the push rod has been moved to the critical position, and then the driving device can be controlled to stop working or drive the push rod backward. The gap between the blocking piece and the limiting piece can be adjusted, and the present invention can be applied to wires and heat shrinkable tubes with various diameters. The elastic device is used to help the blocking piece and the limiting piece clamp the wire, which can not only maintain the stability of the wire in the alignment process, but also ensure that the insulation heat shrinkable tube will be pushed to the predetermined position.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A push device, comprising:
a driving device configured to generate a driving force;
a transmission mechanism flexibly connected with the driving device; and
a pushing part fixedly connected with the transmission mechanism and being movable under the drive of the transmission mechanism,
wherein when the pushing part is moved, the pushing part transmits a pushed part to a predetermined position;
wherein when the pushed part is transmitted to the predetermined position, the driving force of the driving device stops acting on the driving mechanism.

2. The push device according to claim 1,
wherein two pushing parts are provided, and at least one of the two pushing parts is movably provided, and the movable pushing part is configured to be moved close to or far away from the other pushing part.

3. The push device according to claim 2,
wherein the driving device simultaneously drives the two pushing parts to move close to each other or far away from each other through the transmission mechanism.

4. The push device according to claim 3,
wherein the transmission mechanism comprising:
a gear; and
two racks respectively meshed with the gear and linked through the gear,
wherein the two racks are configured to be moved in a straight line in opposite directions and respectively connected with the two pushing parts.

5. The push device according to claim 4, further comprising:
a flexible connecting device,
wherein the driving device drives at least one of the two racks to move by the flexible connecting device.

6. The push device according to claim 5,
wherein the flexible connecting device comprising:
a push rod fixedly connected with the driving device and driven to move by the driving device; and
a connecting spring, one end of the which butts against the push rod, and the other end directly or indirectly butts against one of the two racks;
wherein when the push rod is driven to move by the driving device, the push rod butts the connecting spring and pushes one of the two racks to move by the connecting spring.

7. The push device according to claim 6,
wherein before the pushed part reaches the predetermined position, the driving force of the driving device is transmitted to the transmission mechanism through the push rod and the connecting spring;
wherein when the pushed part reaches the predetermined position, the driving force of the driving device causes the connecting spring to be compressed and deformed, and causes the push rod to move relative to the connecting spring.

8. The push device according to claim 6,
wherein a flange is provided on the push rod, the connecting spring is sheathed on the push rod and butted against the flange.

9. The push device according to claim 6,
wherein the flexible connecting device further comprises a first block connected with one of the two racks and butts against the other end of the connecting spring;
wherein the push rod passes through the first block and is provided with a gap with the first block.

10. The push device according to claim 6,
wherein the flexible connecting device further comprising:
a second block; and
a connecting member configured to connect the first block and the second block,
wherein the first block is spaced from the second block, the push rod passes through the second block and is movably provided relative to the second block,
wherein the connecting spring is sheathed on the push rod and is located between the first block and the second block,
wherein a flange is provided on the push rod, one end of the connecting spring butts against the flange and the other end butts against the first block.

11. The push device according to claim 10,
wherein the flange is provided in contact with the second block during movement; and
wherein when the driving device generates a reverse driving force, the flange pushes the second block to move in a reverse direction.

12. The push device according to claim 6, further comprising:
a push rod position sensor,
wherein when the push rod is displaced relative to the connecting spring, the push rod position sensor detects the position of the push rod and generates a control signal to control the driving device to work.

13. The push device according to claim 1,
wherein the pushing part comprises a limiting piece and a blocking piece, and there is a gap between the limiting piece and the blocking piece;
wherein the blocking piece is movably provided, and the gap is adjusted when the blocking piece is moved.

14. The push device according to claim 13,
wherein the pushing part further comprises an elastic device having elastic force, and the elastic device acts on the blocking piece to move the blocking piece to reduce the gap between the limiting piece and the blocking piece.

15. A wire processing device, comprising:
a heat shrinkable processing device; and
the push device according to claim 1,
wherein the push device configured to transmit an insulation heat shrinkable tube to a predetermined position.

16. A method of processing wire, comprising steps of:
placing a processed wire at a processed position, wherein the processed wire comprises a splicing part;
transmitting an insulation heat shrinkable tube to the splicing part of the processed wire;
stopping the transmission of the insulation heat shrinkable tube when the insulation heat shrinkable tube is transferred to cover the splicing part of the processed wire; and
heating the insulation heat shrinkable tube so that the insulation heat shrinkable tube is shrunk and wrapped on the splicing part of the processed wire.
